(19) United States
(12) Patent Application Publication
(10) Pub. No.: US 2006/0021519 A1
(43) Pub. Date: Feb. 2, 2006

(54) JUICER HAVING AN OVERFLOW RELEASE EFFECT

(75) Inventor: Ying-Hui Shen, Tainan Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Always Plastics Company, Tainan Hsien (TW)

(21) Appl. No.: 10/903,917

(22) Filed: Jul. 30, 2004

(51) Int. Cl. A47J 43/14

(52) U.S. Cl. 99/501

(57) ABSTRACT

A juicer includes a first body, and a second body pivotally mounted on the first body. The first body has a press portion having an inner wall formed with an overflow chamber and having a surface formed with a return hole communicating with the overflow chamber. The second body has a receiving chamber for receiving the press portion. Thus, the residual fruit juice that cannot flow outward from the central hole and the outlet holes of the receiving chamber is introduced through the return hole into the overflow chamber and is then poured outward from the outlet opening of the overflow chamber, thereby collecting the juice to the maximum extent.

### BACKGROUND OF THE INVENTION

1. Field of the Invention

The present invention relates to a juicer, and more particularly to a juicer having an overflow release effect.

2. Description of the Related Art

A conventional juicer 1 in accordance with the prior art shown in FIGS. 8 and 9 comprises a first body 11, and a second body 12 pivotally mounted on the first body 11. The first body 11 has a first end formed with a pivot seat 111, a mediate portion formed with a press portion 113 having a protruding boss 1131 and a second end formed with a first handle 114. The second body 12 has a first end formed with a pivot shaft 121 pivotally mounted on the pivot seat 111 of the first body 11 by a pivot rod 112, a mediate portion formed with a receiving chamber 122 for receiving the press portion 113 of the first body 11 and a second end formed with a second handle 123. The receiving chamber 122 of the second body 12 has a surface formed with a protrusion 1221 formed with a plurality of outlet holes 1223 and a central hole 1222 located at a center of the outlet holes 1223 to receive the protruding boss 1131 of the press portion 113 of the first body 11.

In operation, a fruit “A” is placed into the receiving chamber 122 of the second body 12 as shown in FIG. 9, with the flesh “A1” of the fruit “A” facing upward. Then, the first handle 114 of the first body 11 is moved toward the second handle 123 of the second body 12, so that the press portion 113 of the first body 11 is inserted into the receiving chamber 122 of the second body 12 to press and squeeze the flesh “A1” of the fruit “A” contained in the receiving chamber 122 of the second body 12, thereby forming fruit juice “A2” which is dropped outward from the central hole 1222 and the outlet holes 1223 of the receiving chamber 122 of the second body 12.

However, the residual fruit juice “A3” that cannot flow outward from the central hole 1222 and the outlet holes 1223 of the receiving chamber 122 of the second body 12 is sputtered outward from the receiving chamber 122 of the second body 12, thereby causing consumption of the residual fruit juice “A3”, and thereby wasting the manual work.

### SUMMARY OF THE INVENTION

In accordance with the present invention, there is provided a juicer, comprising a first body, and a second body pivotally mounted on the first body, wherein:
the first body has a mediate portion formed with a press portion having an inner wall formed with an overflow chamber and having a surface formed with a return hole communicating with the overflow chamber; and
the second body has a mediate portion formed with a receiving chamber for receiving the press portion of the first body.

The primary objective of the present invention is to provide a juicer having an overflow release effect.

Another objective of the present invention is to provide a juicer, wherein the residual fruit juice that cannot flow outward from the central hole and the outlet holes of the receiving chamber of the second body is introduced through the return hole of the press portion of the first body into the overflow chamber and is then poured outward from the outlet opening of the overflow chamber, thereby collecting the juice to the maximum extent.

A further objective of the present invention is to provide a juicer, wherein the guide ribs guide the fruit juice to flow toward the central hole and the outlet holes of the receiving chamber of the second body rapidly and smoothly, thereby facilitating a user squeezing the flesh of the fruit.

A further objective of the present invention is to provide a juicer, wherein by provision of the guide ribs, a gap is defined between the flesh of the fruit and the receiving chamber of the second body, thereby facilitating the fruit juice flowing in the receiving chamber of the second body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a juicer in accordance with the preferred embodiment of the present invention;

FIG. 2 is an exploded perspective view of the juicer as shown in FIG. 1;

FIG. 3 is a perspective view of a first body of the juicer as shown in FIG. 1;

FIG. 4 is a perspective view of a second body of the juicer as shown in FIG. 1;

FIG. 5 is a plan cross-sectional view of the juicer as shown in FIG. 1;

FIG. 6 is a schematic operational view of the juicer as shown in FIG. 5;

FIG. 7 is a schematic operational view of the juicer as shown in FIG. 1;

FIG. 8 is a plan cross-sectional assembly view of a conventional juicer in accordance with the prior art; and

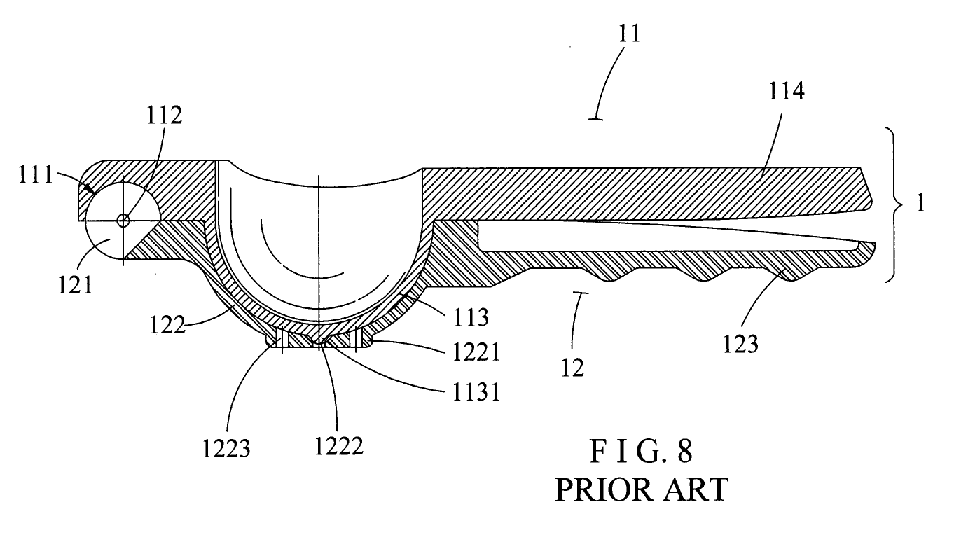

FIG. 9 is a schematic operational view of the conventional juicer as shown in FIG. 8.

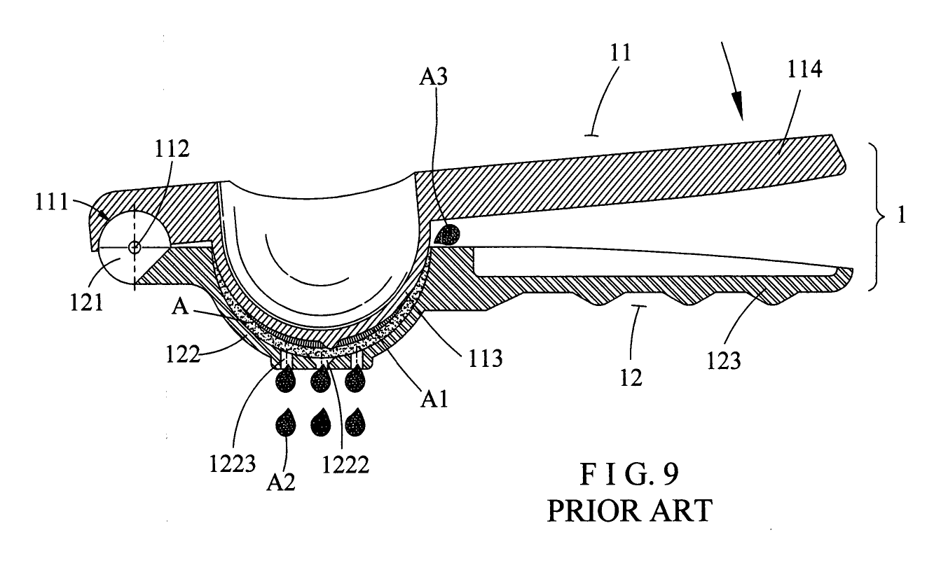

### DETAILED DESCRIPTION OF THE INVENTION

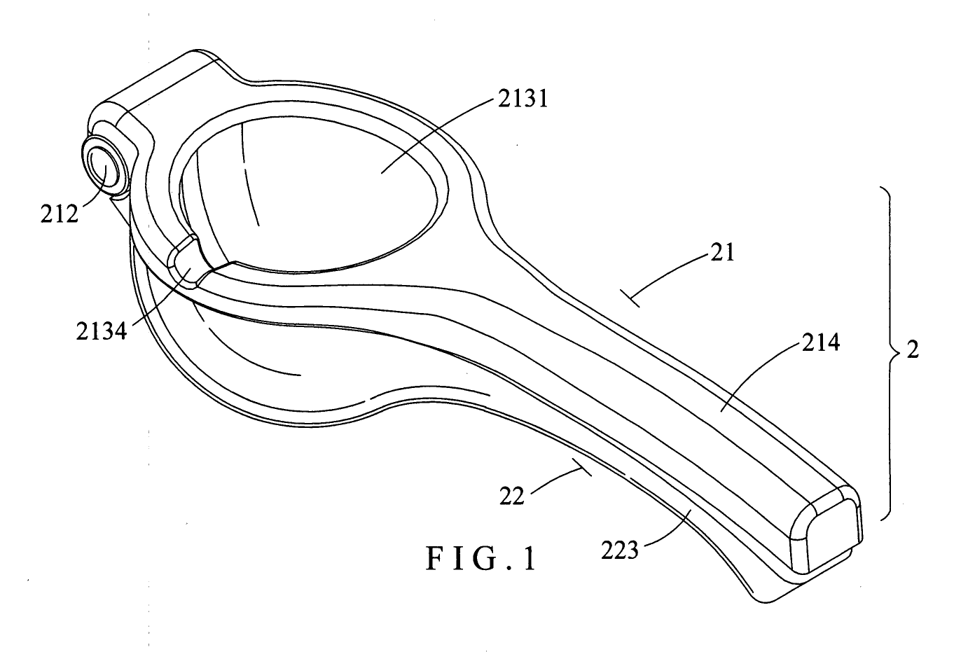

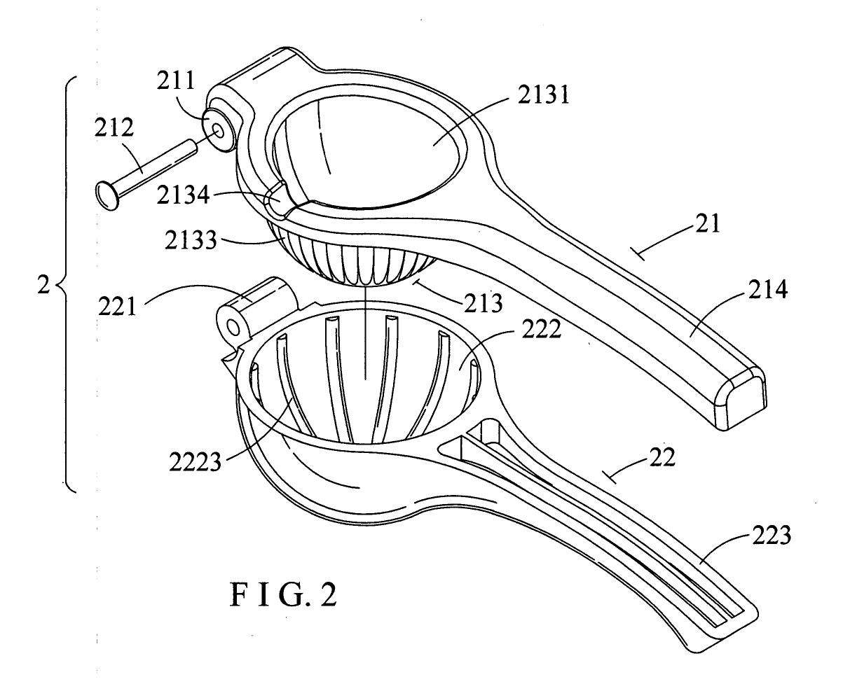

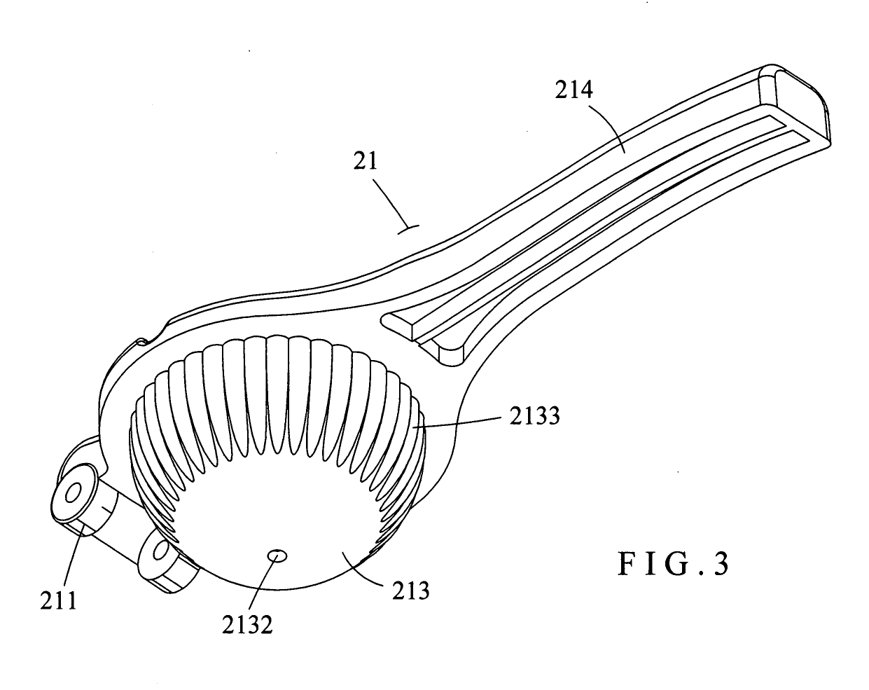

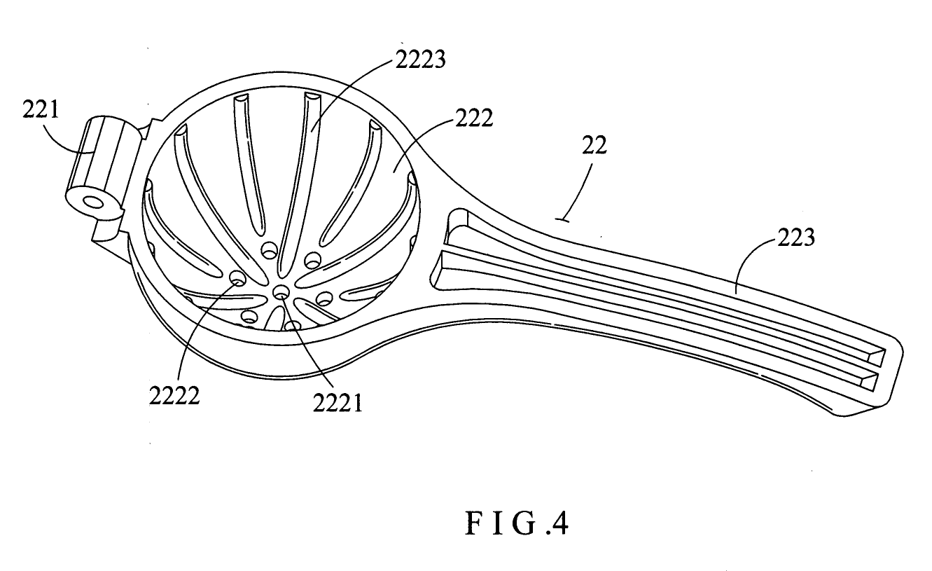

Referring to the drawings and initially to FIGS. 1-5, a juicer 2 in accordance with the preferred embodiment of the present invention comprises a first body 21, and a second body 22 pivotally mounted on the first body 21.

The first body 21 has a mediate portion formed with a press portion 213 protruding outward therefrom. The press portion 213 of the first body 21 has a semi-spherical shape. The press portion 213 of the first body 21 has an inner wall formed with an overflow chamber 2131 and has a surface formed with a return hole 2132 communicating with the overflow chamber 2131. Preferably, the return hole 2132 of the press portion 213 of the first body 21 is located at a central portion of the surface of the press portion 213. The press portion 213 of the first body 21 has an outer wall formed with a plurality of elongated press ribs 2133. The overflow chamber 2131 of the press portion 213 of the first body 21 has a side formed with an outlet opening 2134. The first body 21 has a first end formed with a hollow pivot seat 211 and a second end formed with a first handle 214.

The second body 22 has a mediate portion formed with a receiving chamber 222 for receiving the press portion 213 of the first body 21. The receiving chamber 222 of the second body 22 has a semi-spherical shape and communicates with the return hole 2132 of the press portion 213 of the first body 21. The receiving chamber 222 of the second body 22 has a surface formed with a plurality of outlet holes 2222 arranged in an annular manner and each communicating with the receiving chamber 222. The surface of the receiving chamber 222 of the second body 22 has a central portion formed with a central hole 2221 communicating with the receiving chamber 222 and located at a center of the outlet holes 2222. The receiving chamber 222 of the second body 22 has an inner peripheral wall formed with a plurality of elongated guide ribs 2223 connected to the central hole 2221 and the outlet holes 2222 of the receiving chamber 222 of the second body 22. The second body 22 has a first end formed with a pivot shaft 221 pivotally mounted on the pivot seat 211 of the first body 21 by a pivot rod 212 and a second end formed with a second handle 223.

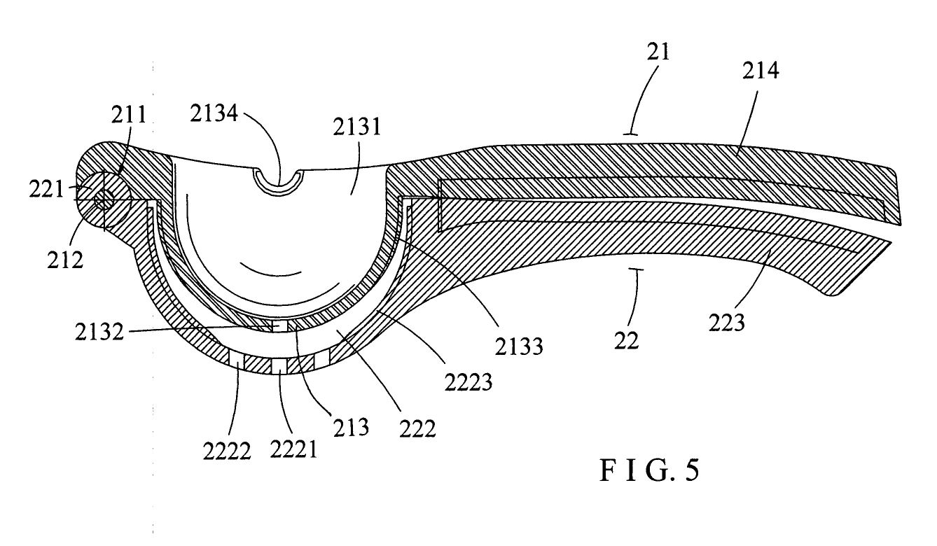

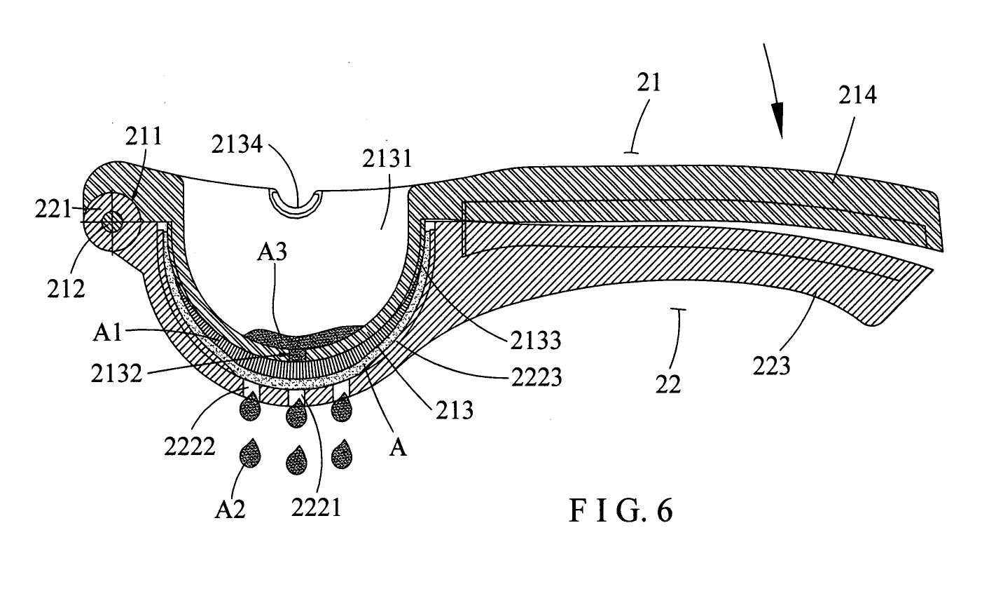

In operation, referring to FIGS. 5-7 with reference to FIGS. 1-4, a fruit “A” is placed into the receiving chamber 222 of the second body 22 as shown in FIG. 6, with the flesh “A1” of the fruit “A” facing upward. Then, the first handle 214 of the first body 21 is moved toward the second handle 223 of the second body 22, so that the press portion 213 of the first body 21 is inserted into the receiving chamber 222 of the second body 22 to press and squeeze the flesh “A1” of the fruit “A” contained in the receiving chamber 222 of the second body 22, thereby forming fruit juice “A2” which is dropped outward from the central hole 2221 and the outlet holes 2222 of the receiving chamber 222 of the second body 22.

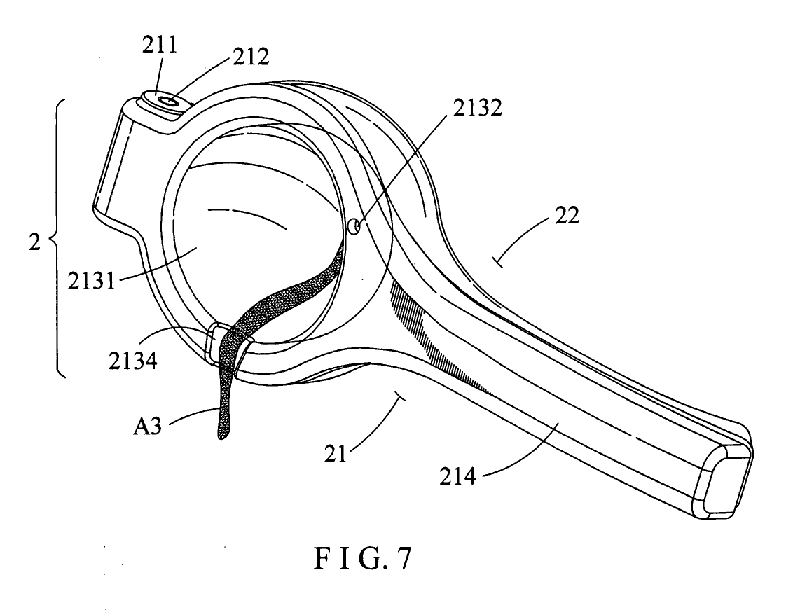

Accordingly, by provision of the guide ribs 2223, a gap is defined between the flesh “A1” of the fruit “A” and the receiving chamber 222 of the second body 22, thereby facilitating the fruit juice “A2” flowing in the receiving chamber 222 of the second body 22. In addition, the guide ribs 2223 guide the fruit juice “A2” to flow toward the central hole 2221 and the outlet holes 2222 of the receiving chamber 222 of the second body 22 rapidly and smoothly, thereby facilitating a user squeezing the flesh “A1” of the fruit “A”. Further, the residual fruit juice “A3” that cannot flow outward from the central hole 2221 and the outlet holes 2222 of the receiving chamber 222 of the second body 22 is introduced through the return hole 2132 of the press portion 213 of the first body 21 into the overflow chamber 2131 and is then poured outward from the outlet opening 2134 of the overflow chamber 2131 as shown in FIG. 7, thereby collecting the juice to the maximum extent.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A juicer, comprising a first body, and a second body pivotally mounted on the first body, wherein:
the first body has a mediate portion formed with a press portion having an inner wall formed with an overflow chamber and having a surface formed with a return hole communicating with the overflow chamber;
the second body has a mediate portion formed with a receiving chamber for receiving the press portion of the first body;
the press portion of the first body has an outer wall formed with a plurality of elongated press ribs.

2. The juicer in accordance with claim 1, wherein the press portion of the first body has a semi-spherical shape.

3. The juicer in accordance with claim 1, wherein the press portion of the first body is protruding outward from the first body.

4. The juicer in accordance with claim 1, wherein the return hole of the press portion of the first body is located at a central portion of the surface of the press portion.

5. (canceled)

6. The juicer in accordance with claim 1, wherein the overflow chamber of the press portion of the first body has a side formed with an outlet opening.

7. The juicer in accordance with claim 1, wherein the receiving chamber of the second body has a semi-spherical shape.

8. The juicer in accordance with claim 1, wherein the receiving chamber of the second body communicates with the return hole of the press portion of the first body.

9. A juicer, comprising a first body, and a second body pivotally mounted on the first body, wherein:
the first body has a mediate portion formed with a press portion having an inner wall formed with an overflow chamber and having a surface formed with a return hole communicating with the overflow chamber;
the second body has a mediate portion formed with a receiving chamber for receiving the press portion of the first body;
the receiving chamber of the second body has a surface formed with a plurality of outlet holes arranged in an annular manner and each communicating with the receiving chamber;
the surface of the receiving chamber of the second body has a central portion formed with a central hole communicating with the receiving chamber and located at a center of the outlet holes;
the receiving chamber of the second body has an inner peripheral wall formed with a plurality of elongated guide ribs connected to the central hole and the outlet holes of the receiving chamber of the second body.

10. (canceled)

11. (canceled)

12. A juicer, comprising a first body, and a second body pivotally mounted on the first body, wherein:
the first body has a mediate portion formed with a press portion having an inner wall formed with an overflow chamber and having a surface formed with a return hole communicating with the overflow chamber;
the second body has a mediate portion formed with a receiving chamber for receiving the press portion of the first body;
the receiving chamber of the second body has an inner peripheral wall formed with a plurality of elongated guide ribs.

13. The juicer in accordance with claim 1, wherein the first body has a first end formed with a hollow pivot seat, the second body has a first end formed with a pivot shaft pivotally mounted on the pivot seat of the first body by a pivot rod.

14. The juicer in accordance with claim 1, wherein the first body has a second end formed with a first handle.

15. The juicer in accordance with claim 1, wherein the second body has a second end formed with a second handle.
